(19) United States
(12) Patent Application Publication
(10) Pub. No.: US 2020/0071429 A1
(43) Pub. Date: Mar. 5, 2020

(54) PROCESS FOR ACTIVATING A CATALYST FOR THE POLYMERIZATION OF ETHYLENE

(71) Applicant: BASELL POLIOLEFINE ITALIA S.R.L., MILANO (IT)

(72) Inventors: PIETRO BAITA, OCCHIOBELLO (IT); DARIO LIGUORI, FERRARA (IT); HARILAOS MAVRIDIS, LEBANON, OH (US); GIAMPIERO MORINI, FERRARA (IT); ROBERTA PICA, FERRARA (IT)

(73) Assignee: BASELL POLIOLEFINE ITALIA S.R.L., MILANO (IT)

(21) Appl. No.: 16/610,794

(22) PCT Filed: Apr. 27, 2018
(86) PCT No.: PCT/EP2018/060916

§ 371 Date: Nov. 4, 2019

Related U.S. Application Data
(60) Provisional application No. 62/505,556, filed on May 12, 2017.

(51) Int. Cl. C08F 4/655; C08F 210/16; C08F 2/34; C08F 4/651

(52) U.S. Cl. CPC C08F 4/6555; C08F 4/651; C08F 2/34; C08F 210/16

(57) ABSTRACT

A solid catalyst component (i) made from or containing a titanium compound, a magnesium compound and an ether, is activated by using two different aluminum alkyl compounds (ii) and (iii) in sequence and under specific molar ratios relative to each other and to the ether of the solid catalyst component (i).

### FIELD OF THE INVENTION

In general, the present disclosure relates to the field of chemistry. More specifically, the present disclosure relates to polymer chemistry. In particular, the present disclosure relates to a process for the activation of a catalyst for the polymerization of ethylene and mixtures of ethylene with olefins of the formula CH₂₌CHR, where R is an alkyl, cycloalkyl or aryl radical having 1-12 carbon atoms.

### BACKGROUND OF THE INVENTION

In some instances, gas-phase polymerization is a technique for the preparation of polyethylene, which is carried out in a fluidized or stirred-bed reactor in the presence of a catalyst, ethylene, fluidization gas and a molecular weight regulator. In some instances, the molecular weight regulator is hydrogen.

Catalyst performance for gas-phase ethylene polymerization activity may depend on the polymerization conditions, such as temperature and pressure. However, once the polymerization conditions are fixed, the activity depends on the catalyst system. When the activity of the catalyst system is not satisfactory, the amount of catalyst fed to the reactor, the residence time may be increased, or both. However, these changes increase the plant operability costs. An increase of catalyst fed results in an increase of the cost per unit of polymer produced while an increase of residence time results in a lower productivity of the plant.

In some instance, titanium (Ti) based Ziegler-Natta catalysts is used for gas-phase polymerization of ethylene in combination with aluminum alkyl compounds.

### SUMMARY OF THE INVENTION

In a general embodiment, the present disclosure provides a process for pre-activating a catalyst for the polymerization of olefins including the steps of:

(a) contacting a solid catalyst component (i) made from or containing a titanium compound, a magnesium compound and an ether with (ii) an aluminum compound of the formula AlR₃, wherein R is a C₁-C₁₀ linear or branched alkyl compound;

(b) contacting the product resulting from step (a) with an aluminum compound (iii) of the formula AlClₙR₃₋ₙ, wherein n ranges from 1 to less than 3 and R is a C₁-C₁₀ linear or branched alkyl, where the process has a molar ratio between the aluminum compound (iii) and the aluminum compound (ii) of 2.5 or less and the molar ratio between the sum of aluminum compounds (ii) and (iii) and the ether present in the solid catalyst component (i) is equal to, or lower than, 0.6, thereby providing a pre-activated catalyst.

### DETAILED DESCRIPTION OF THE INVENTION

In some embodiments, the aluminum compound (ii) of the formula AlR₃ is selected from compounds wherein R is a C₁-C₈ alkyl group, including a linear alkyl group. In some embodiments, the aluminum compound (ii) is selected from the group consisting of tri-n-hexyl aluminum and tri-n-octyl aluminum.

In some embodiments, the aluminum compound (iii) of the formula AlClₙR₃₋ₙ is selected from compounds wherein n ranges from 1 to 2 and R is a C₁-C₄ alkyl group. In some embodiments, compounds the aluminum compound (iii) is selected from the group consisting of ethylaluminum dichloride, diethylaluminum chloride and ethylaluminum sesquichloride.

In some embodiments, the molar ratio of compounds (iii)/(ii) ranges from 1 to 2.3, alternatively from 1.2 to 2.

In some embodiments, the molar ratio between the sum of the aluminum compounds (ii) and (iii) and the ether present in the solid catalyst component (i) ranges from 0.30 to 0.55, alternatively from 0.35-0.50.

In some embodiments, the molar ratio between the sum of the aluminum compounds (ii) and (iii) and the ether present in the solid catalyst component (i) ranges from 0.46 to 0.55, and the molar ratio of compounds (iii)/(ii) ranges from 1 to 1.5.

In some embodiments, the molar ratio between the sum of aluminum compounds (ii) and (iii) and the ether present in the solid catalyst component (i) ranges from 0.35 to 0.45, and the molar ratio of compounds (iii)/(ii) ranges from 1.6 to 2.

In some embodiments, tri-n-hexyl aluminum is used as compound (ii) and diethyl aluminum chloride is used as compound (iii).

In some embodiments, the contacting of the components in step (a) is carried out for a period of time ranging from 20 to 400 minutes, alternatively from 50 to 300 minutes.

In some embodiments, the contacting in step (a) is carried out in a liquid diluent at a temperature ranging from 0 to 90° C., alternatively from 20 to 70° C.

In some embodiments, the contacting of the components in step (b) is carried out for a period of time shorter than the contacting time in (a). In some embodiments, the contacting in step (b) is carried out for a period of time ranging from 10-300 minutes, alternatively from 20-250 minutes. In some embodiments, the contacting in step (b) is carried out at a temperature ranging from 0-90° C., alternatively from 20-70° C. In some embodiments, step (b) takes place in an inert diluent.

In some embodiments, the titanium compounds in the solid catalyst component (i) has the formula Ti(OR¹)ₘX_{y-m,} wherein m is 0-0.5 inclusive, y is the valence of titanium, R¹ is an alkyl, cycloalkyl or aryl radical having 1-8 carbon atoms, and X is a halogen. In some embodiments, R¹ is selected from the group consisting of ethyl, isopropyl, n-butyl, isobutyl, 2-ethylhexyl, n-octyl and phenyl(benzyl) group. In some embodiments, X is chlorine.

In some embodiments, if y is 4, m is from 0-0.02, and if y is 3, m is from 0 to 0.015. In some embodiments, TiCl₄ is used as the titanium compound.

In some embodiments, the Mg/Ti molar ratio ranges from 7 to 50, alternatively from 10 to 25.

The solid catalyst component (i) also is made from or contains an ether as internal donor. The ether (E) is present in amount such as to give (E)/Ti molar ratios from 4 to 20, alternatively from 6 to 16, alternatively from 10 to 15.

In some embodiments, ethers such as cyclic alkyl ethers having from 2-6 carbon atoms are used. In some embodiments, the cyclic alkyl ether is tetrahydrofuran.

In some embodiments, the solid catalyst component (i) has a porosity P_{F} (deriving from pores with radius up to 1 μ) as determined using the mercury method of 0.20-0.80 cm³/g, alternatively from 0.30-0.70 cm³/g.

In some embodiments, the surface area measured by the BET method is lower than 80, alternatively from 10-70 m²/g. In some embodiments, the porosity as measured by the Brunauer-Emmett-Teller (BET) method ranges from 0.10-0.50 cm³/g, alternatively from 0.10-0.40 cm³/g.

In some embodiments, the particles of the solid component of the catalyst system have a spherical morphology and an average diameter ranging from 30-150 μm, alternatively from 40-100 μm. As used herein, the phrase “particles having spherical morphology” and related phrases are used to describe particles having a ratio between the greater axis and the smaller axis equal to or lower than 1.5, alternatively lower than 1.3.

In some embodiments, a method for the preparation of spherical components described herein includes a step (a) wherein a compound MgCl₂.mR¹¹OH, where 0.3≤m≤1.7 and R¹¹ is an alkyl, cycloalkyl or an aryl radical having 1-12 carbon atoms, is reacted with a titanium compound of the formula Ti(OR¹)ₙX₄₋ₙ, wherein n, y, X and R¹ have the same meaning as defined above.

In some embodiments, MgCl₂.mR¹¹OH is made from or contains a precursor of a Mg dihalide compound. In some embodiments, these compounds are obtained by mixing alcohol and magnesium chloride in the presence of an inert hydrocarbon immiscible with a spherical adduct under stirring conditions at the melting temperature of the adduct (100-130° C.). The emulsion is quenched, causing the solidification of the adduct in form of spherical particles. In some embodiments, the methods for preparing these spherical adducts are U.S. Pat. Nos. 4,469,648 and 4,399,054, and Patent Cooperation Treaty Publication No. WO 98/44009. In some embodiments, the method for spherulization is spray cooling as described in U.S. Pat. Nos. 5,100,849 and 4,829,034. In some embodiments, adducts having a functional alcohol content are obtained by directly using the selected amount of alcohol directly during the adduct preparation. In some embodiments, if adducts with increased porosity are to be obtained, the adducts are prepared with more than 1.7 moles of alcohol per mole of MgCl₂. In some embodiments, the adducts are then subjected to a thermal or chemical dealcoholation process. In some embodiments, the thermal dealcoholation process is carried out under nitrogen flow at temperatures between 50-150° C. until the alcohol content is reduced to the value ranging from 0.3-1.7. In some embodiments, the process is as disclosed in European Patent Application No. EP-A-395083.

In some embodiments, the dealcoholated adducts have a porosity (as measured by the mercury method), due to pores with radius up to 1 μm, ranging from 0.15 to 2.5 cm³/g, alternatively from 0.25-1.5 cm³/g.

In some embodiments, in the reaction of step (a) the molar ratio Ti/Mg is stoichiometric or higher; alternatively higher than 3. In some embodiments, a large excess of titanium compound is used. In some embodiments, the titanium compounds are titanium tetrahalides such as TiCl₄. In some embodiments, the reaction with the Ti compound is carried out by suspending the adduct in cold TiCl₄. In some embodiments, the temperature is about 0° C. Next and in some embodiments, the mixture is heated up to 80-140° C. and kept at this temperature for 0.5-8 hours, alternatively 0.5-3 hours. In some embodiments, excess titanium compound is separated at high temperatures by filtration or sedimentation and siphoning. In some embodiments, step (a) is repeated twice or more.

In some embodiments and in a subsequent step (b), the intermediate solid is brought into contact with the ether compound under conditions to affix the intermediate solid on the solid produced in step (a).

In some embodiments, the reaction is carried out under conditions such that the ether is added to the reaction mixture alone or in a mixture with other compounds, wherein the ether is the main component in terms of molar concentration. In some embodiments, the contact is carried out in a liquid medium such as a liquid hydrocarbon. In some embodiments, the temperature at which the contact takes place depends on the nature of the reagents and ranges from −10 to 150° C., alternatively from 0-120° C. Temperatures that may cause the decomposition or degradation of a reagent should be avoided. In some embodiments, the time of the treatment depends on other conditions such as nature of the reagents, temperature, and concentration. In some embodiments, the contact step lasts from 10 minutes to 10 hours, alternatively from 0.5-5 hours. In some embodiments and to increase the final donor content, this step is repeated one or more times. In some embodiments and at the end of this step, the solid is recovered by separation of the suspension via settling and removing of the liquid, filtration, or centrifugation. In some embodiments, the solid is subject to washings with solvents. In some embodiments, the washings are carried out with inert hydrocarbon liquids. In some embodiments, the washings are carried with more polar solvents, alternatively halogenated or oxygenated hydrocarbons. In some embodiments, the more polar solvents have a higher dielectric constant than the inert hydrocarbon liquids.

In some embodiments, a further step (c) is carried out where the solid product recovered from step (b) is subject to a thermal treatment at temperatures ranging from 70 to 150° C., alternatively from 80 to 130° C., alternatively from 85-100° C.

In some embodiments and for thermal treatment, the solid coming from step (b) is suspended in an inert diluent like a hydrocarbon and then subjected to heating while maintaining the system under stirring.

In some embodiments and for thermal treatment, the solid is heated in a dry state by inserting the solid in a device having jacketed heated walls. In some embodiments, stirring is provided by mechanical stirrers.

In some embodiments and for thermal treatment, the solid produced in step (b) is heated by a flow of hot inert gas such as nitrogen. In some embodiments, the solid is maintained under fluidization conditions.

In some embodiments, the heating time depends on conditions such as the maximum temperature reached. In some embodiments, the heating time ranges from 0.1-10 hours, alternatively from 0.5-6 hours. It is believed that higher temperatures may allow the heating time to be shorter while lower temperatures may cause longer reaction times.

In some embodiments, each of steps (b)-(c) is carried out immediately after the previous step, without the need for isolating the solid product coming from the previous step. In some embodiments, the solid product coming from one step is isolated and washed before being subjected to the subsequent step.

In some embodiments and after the activation step with compounds (ii) and (iii), the pre-activated catalyst (A) is contacted with a catalyst component (B) to complete the activation and form the final catalyst system used to polymerize olefins.

The catalyst component (B) (also called the cocatalyst) is selected from Al-alkyl compounds that are optionally halogenated. In some embodiments, the cocatalyst is selected from Al-trialkyl compounds, alternatively, selected from the group consisting of Al-trimethyl, Al-triethyl, Al-tri-n-butyl, and Al-triisobutyl compounds. In some embodiments, the Al/Ti ratio is higher than 1, alternatively from 5-800.

In some embodiments, the contact between the preactivated catalyst and the catalyst component (B) proceeds from feeding separately the components into the polymerization reactor under polymerization conditions. In some embodiments, the components are mixed upfront and then fed together into the polymerization reactor.

In some embodiments, ethylene, optionally in a mixture with C₃-C₈ alpha-olefins, is polymerized in gas phase in the further presence of the catalyst.

In some embodiments, the gas-phase polymerization process is carried out at a temperature ranging from 60-130° C., alternatively from 70 to 110° C. In some embodiments, the total pressure of the gas-phase reactor ranges from 10-40 bar, alternatively from 15-35 bar. In some embodiments, the fluidizing inert gas is selected from the group consisting of nitrogen and propane. In some embodiments, hydrogen is used as a molecular weight regulator.

In some embodiments, the gas-phase reactor is a fluidized bed reactor as described in U.S. Pat. Nos. 6,187,866 and 4,482,687. In some embodiments, two reactors in series are employed to carry out the polymerization.

In some embodiments, a gas-phase process for the polymerization of olefins includes the following steps in any mutual order:
a) polymerizing ethylene, optionally together with one or more comonomers, in a first gas-phase reactor in the presence of hydrogen and a catalyst system; and
b) polymerizing ethylene optionally with one or more comonomers in a second gas-phase reactor in the presence of hydrogen and the catalysts system of step (a);
wherein, in at least one of the gas-phase reactors, the growing polymer particles flow upward through a first polymerization zone (riser) under fast fluidization or transport conditions, leave the riser and enter a second polymerization zone (downcomer) through which the growing polymer particles flow downward under the action of gravity, leave the downcomer and are reintroduced into the riser, thereby establishing a circulation of polymer between the two polymerization zones.
   In some embodiments and in the first polymerization zone (the riser), fast fluidization conditions is established by feeding a gas mixture made from or containing one or more olefins (that is, ethylene and comonomer(s)) at a velocity higher than the transport velocity of the polymer particles. In some embodiments, the velocity of the gas mixture is 0.5-15 m/s, alternatively 0.8-5 m/s. The terms “transport velocity” and “fast fluidization conditions” are used herein as defined in D. Geldart, Gas Fluidisation Technology, J. Wiley & Sons Ltd., (1986).

In the second polymerization zone (the downcomer), the polymer particles flow under the action of gravity in a densified form such that high density values are reached (as defined by mass of polymer per volume of reactor), which approaches the bulk density of the polymer. In other words, the polymer flows vertically down through the downcomer in a plug flow (packed flow mode), so that small quantities of gas are entrained between the polymer particles.

In some embodiments, the catalysts are used for preparing very-low-density and ultra-low-density polyethylenes (VLDPE and ULDPE, respectively) having densities of 0.880-0.920 g/cm³ and consisting of ethylene copolymers with one or more alpha-olefins having 3-12 carbon atoms and a molar content of units derived from ethylene of higher than 80 as well as elastomeric copolymers of ethylene and propylene and elastomeric terpolymers of ethylene and propylene with smaller proportions of a diene having a content by weight of units derived from ethylene of about 30-70%.

The following examples are given in order to provide further description of the disclosed process in a non-limiting manner.

### EXAMPLES

### Characterizations

The properties are determined according to the following methods:
MIE flow index: ASTM-D 1238 condition E
Bulk density: DIN-53194

### Example 1-3 and Comparative Examples C1-C2

The polymerization process was carried out in a plant working continuously and equipped with a pre-activation section in which the catalyst components are mixed to form the catalytic system, and a fluidized bed reactor (polymerization reactor) kept under fluidization conditions with propane for receiving the catalyst mixture coming from the stirred vessel.

In the preactivation vessel, a solid catalyst component prepared according to Example 2 of Patent Cooperation Treaty Publication No. WO 2012/025379 was first contacted in liquid propane with tri-n-hexyl aluminum (THA). Subsequently, diethyl aluminum chloride (DEAC) was added to the mixture. The specific amounts of reactants, stirring times and temperatures are reported in Table 1.

The resulting catalytic system was fed, via liquid propane, from the pre-activation section to the gas-phase fluidized bed reactor together with the monomer feed. Also, TEAL cocatalyst was fed to the reactor via a separate line. The operating conditions are reported in Table 1. The polymer discharged from the final reactor was first transferred to the steaming section and then dried at 70° C. under a nitrogen flow and weighed. The polymer properties are reported in Table 1.

TABLE 1

| EXAMPLE | | | C1 | 1 | 2 | C2 | 3 |
|---|---|---|---|---|---|---|---|
| PAS | T | ° C. | 40 | 40 | 40 | 40 | 40 |
| | Time | min | 144 | 144 | 144 | 107 | 107 |
| | THA/cat | wt/wt | 0.32 | 0.32 | 0.32 | 0.32 | 0.20 |
| | THA/THF | mol | 0.25 | 0.23 | 0.24 | 0.25 | 0.15 |
| | T | ° C. | 40 | 40 | 40 | 40 | 40 |
| | Time | min | 90 | 90 | 90 | 80 | 80 |
| | DEAC/cat | wt/wt | 0.25 | 0.13 | 0.08 | 0.25 | 0.25 |
| | DEAC/THF | mol | 0.45 | 0.23 | 0.14 | 0.45 | 0.45 |
| | THA + DEAC/THF | Mol ratio | 0.7 | 0.46 | 0.38 | 0.7 | 0.60 |
| FBR | T | ° C. | 86 | 86 | 86 | 86 | 86 |
| | P | bar | 21 | 21 | 21 | 21 | 21 |
| | TEAL/cat | wt/wt | 2.4 | 2.4 | 2.4 | 2.1 | 2.2 |
| | C₂_{^{−}} | % mol | 32.4 | 31.6 | 23.8 | 40.7 | 41.4 |
| | H₂/C₂_{^{−}} | mol ratio- | 0.28 | 0.30 | 0.38 | 0.26 | 0.27 |
| | C6⁻/(C6⁻ + C2⁻) | mol ratio | 0.02 | 0.02 | 0.02 | 0.040 | 0.040 |
| | Spec. Mileage | g/(g * h * bar) | 418 | 646 | 1308 | 706 | 831 |
| | MIE | g/10′ | 1.95 | 2.16 | 2.19 | 2.22 | 1.96 |
| | PBD | g/cc | 0.415 | 0.432 | 0.460 | 0.345 | 0.343 |

What is claimed is:

1. A process for pre-activating a catalyst for the polymerization of olefins comprising the steps of:
(a) contacting a solid catalyst component (i) comprising a titanium compound, a magnesium compound and an ether compound with (ii) an aluminum compound of the formula AlR₃, wherein R is a C₁-C₁₀ linear or branched alkyl compound;
(b) contacting the product from step (a) with an aluminum compound (iii) of the formula AlClₙR_{3-n,} wherein n ranges from 1 to less than 3 and R is a C₁-C₁₀ linear or branched alkyl compound,
having a molar ratio between the aluminum compound (iii) and the aluminum compound (ii) of 2.5 or less and a molar ratio between the sum of aluminum compound (ii) and (iii) and the ether present in the solid catalyst component (i) of equal to, or lower than, 0.6, thereby providing a pre-activated catalyst.

2. The process of claim 1, wherein the aluminum compound (ii) of the formula AlR₃ is selected from compounds wherein R is a C₁-C₈ alkyl.

3. The process of claim 2, wherein the aluminum compound (ii) is selected from the group consisting of tri-n-hexyl aluminum and tri-n-octyl aluminum.

4. The process of claim 1, wherein the aluminum compound (iii) of the formula AlClₙR₃₋ₙ is selected from compounds wherein n ranges from 1-2 and R is a C₁-C₄ alkyl group.

5. The process of claim 4, wherein the aluminum compound (iii) is selected from the group consisting of ethylaluminum dichloride, diethylaluminum chloride and ethylaluminum sesquichloride.

6. The process of claim 1, wherein the molar ratio of compounds (iii)/(ii) ranges from 1 to 2.3.

7. The process of claim 1, wherein the molar ratio between the sum of aluminum compound (ii) and (iii) and the ether present in the solid catalyst component (i) ranges from 0.30 to 0.55.

8. The process of claim 6, where wherein the molar ratio between the sum of aluminum compound (ii) and (iii) and the ether present in the solid catalyst component (i) ranges from 0.46 to 0.55 and the molar ratio of compounds (iii)/(ii) ranges from 1 to 1.5.

9. The process of claim 6, wherein the molar ratio between the sum of aluminum compound (ii) and (iii) and the ether present in the solid catalyst component (i) ranges from 0.35 to 0.45 and the molar ratio of compounds (iii)/(ii) ranges from 1.6 to 2.

10. The process according to claim 1, wherein the aluminum compound (ii) is tri-n-hexyl aluminum and the aluminum compound (iii) is diethylaluminum chloride.

11. The process of claim 1, wherein the contact of step (a) is carried out for a period of time ranging from 20 to 400 minutes at a temperature ranging from 0 to 90° C., and the contact of step (b) is carried out for a period of time shorter than that of step (a) at a temperature ranging from 0 to 90° C.

12. The process according to claim 1, wherein the solid catalyst component (i) comprises a titanium compound having the formula Ti(OR¹)ₘX_{y-m,} wherein m is 0-0.5 inclusive, y is the valence of titanium, R¹ is an alkyl, cycloalkyl or aryl radical having 1-8 carbon atoms, X is a halogen and the ether (E) is selected from cyclic alkyl ethers having 2-6 carbon atoms.

13. The process of claim 12, wherein, in the solid catalyst component (i) the molar ratio Mg/Ti ranges from 7 to 50 and the (E)/Ti molar ratios ranges from 4 to 20.

14. A process for the polymerization of ethylene, optionally in a mixture with C₃-C₈ alpha-olefins, carried out in the presence of a catalyst system comprising a pre-activated catalyst (A) prepared according to the process of claim 1, and a catalyst component (B) selected from Al-alkyl compounds.

15. The process according to claim 14, carried out in gas-phase.
